(19) United States
(12) Patent Application Publication
(10) Pub. No.: US 2009/0027522 A1
(43) Pub. Date: Jan. 29, 2009

(54) SYSTEMS AND METHODS FOR ENHANCING EDGE DETECTION

(75) Inventor: Reed May, Seminole, FL (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/828,992

(22) Filed: Jul. 26, 2007

(51) Int. Cl. H04N 5/208

(52) U.S. Cl. 348/252; 348/E05.076

(57) ABSTRACT

Systems and methods for performing edge detection on a surface. An example system includes a camera having a line of sight approximately perpendicular to a plane associated with a camera surface, one or more illumination sources having a line of sight that is less than perpendicular to the plane by a predefined threshold amount, and a processor in signal communication with the camera. The processor receives images generated by the camera, compares the received images, and determines an edge located within one or more of the captured images based on the comparison.

### BACKGROUND OF THE INVENTION

With automated moving vehicles, there is a desire to provide navigation with regard to certain contiguous features, such as road edges, turf edges, curbing, etc. However, it is very difficult to reliably detect and track edge features using passive optical techniques due to large variation in edge contrast due to environmental conditions.

### SUMMARY OF THE INVENTION

The present invention provides systems and methods for performing edge detection on a surface. An example system includes a camera having a line of sight approximately perpendicular to a plane associated with the surface, one or more illumination sources having a line of sight that is less than perpendicular to the plane by a predefined threshold amount, and a processor in signal communication with the camera. The processor receives images generated by the camera, compares the received images, and determines an edge located within one or more of the captured images based on the comparison.

In one aspect of the invention, the illumination sources includes at least one light sources located on opposite sides of the camera.

In another aspect of the invention, the light sources are strobed relative to a frame rate of the camera and a predefined image capturing protocol.

In still another aspect of the invention, the processor separates the received images from the camera into first images that are illuminated by a first one of the light sources and second images that are illuminated by a second one of the light sources. The processor compares one of the first images to one of the second images.

### BRIEF DESCRIPTION OF THE DRAWINGS

Preferred and alternative embodiments of the present invention are described in detail below with reference to the following drawings:

FIG. 1 illustrates a block diagram of a system formed in accordance with an embodiment of the present invention; and

FIGS. 2-4 are side views of various side illumination techniques using the system of FIG. 1.

### DETAILED DESCRIPTION OF THE PREFERRED EMBODIMENT

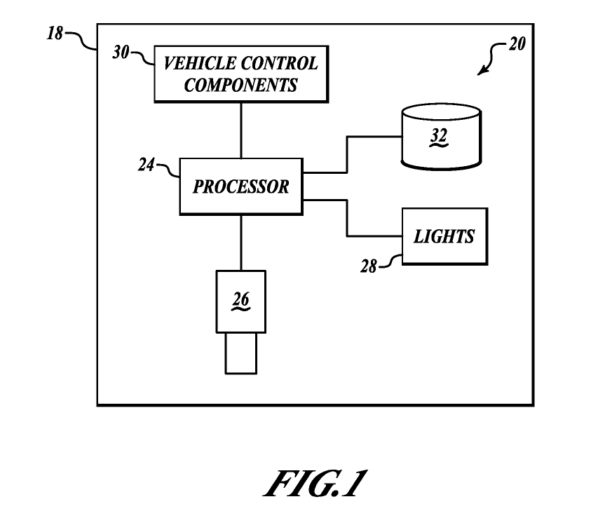

FIG. 1 illustrates a vehicle 18 that has an example system 20 configured to autonomously determine edges and use that information for controlling a vehicle. The system 20 includes at least a processor 24, a camera 26, one or more light sources 28, vehicle control components 30 and memory 32. The processor 24 is in signal communication with the memory 32, the camera 26 and the vehicle control components 30 and may also be in signal communication with the light sources 28.

The camera 26 records images of a surface and sends the recorded images to the processor 24. The one or more light sources 28 illuminate the surface based on a predefined protocol while the camera 26 is recording images. The processor 24 analyzes the recorded images to determine the location of an edge based on predefined threshold requirements. Edge detection information produced by the processor 24 is sent to the vehicle control components 30. The vehicle control components 30 then navigate the vehicle 18 based on predefined navigation rules with regard to the detected edge.

An example technique for using the system 20 or a portion of the system 20 (only one illumination source (light 28) includes continuously illuminating the edge in such a way as to create a strong shadow. The processor 24 uses edge detection processing to locate the illuminated edge.

Another example technique includes alternately illuminating (i.e. strobe) from a first angle where a shadow caused by the edge is formed and an opposing second angle where no shadow is formed. The processor 24 detects the edge by taking a difference of image frames of the different light sources and setting a mid-point (or other value) threshold on the difference data. If the two light sources are of equal brightness, then the average luminance for the non-shadowed area will be nearly equal. Consequently, the difference in the non-shadowed area will be nearly zero while the difference in shadow-non-shadow area will be much larger. Other illumination and processing techniques may be used.

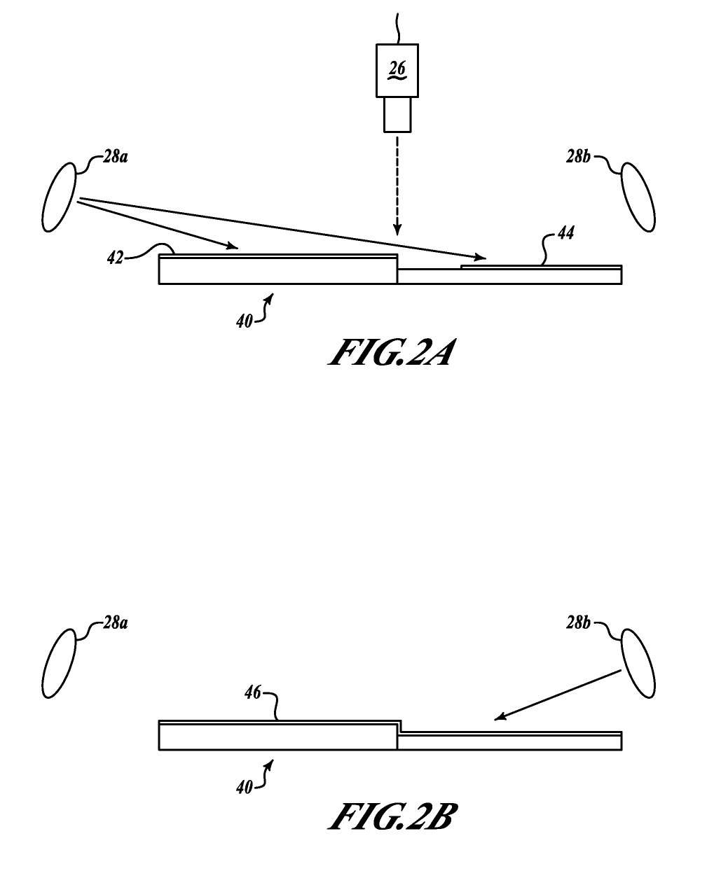

FIGS. 2A, B illustrate an example of the layout of two side light sources 28a, b relative to the camera 26. The exact angle at which the light sources 28a, b is adjustable depending upon the assumed heights and types of edges that are to be detected. In this example the light sources 28a, b are placed so that their line-of-sight (beam angle) is greater than 20° away from the line-of-sight (centerline) of the camera 26.

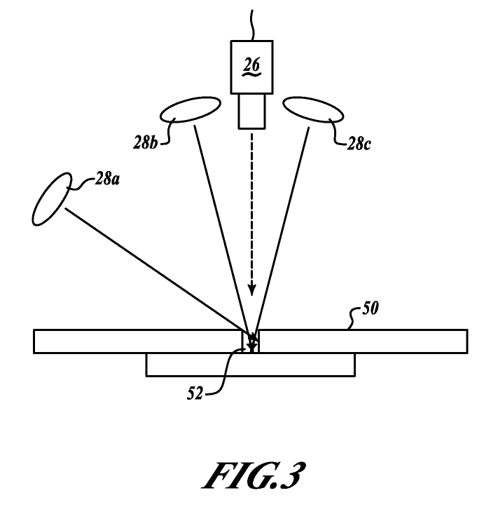

The left light source 28a is first illuminated onto a surface 40, thereby exposing areas 42 and 44 of the surface 40. A gap that is in the shadow between 42 and 44 is not illuminated by light emanating from the light source 28a. The camera 26 then captures that image and stores it in the memory 32. Next, as shown in FIG. 3B, the left light source 28a is deactivated and the right light source 28b is activated, thereby illuminating the entire area 46 of the surface 40. The camera 26 then obtains another image and stores it in the memory 32. Then, the processor 24 compares the stored images to determine changes in various image qualities, such as chrominance or luminance. The processor 24 uses the determined changes in image qualities to perform edge detection. An edge is detected when a threshold number of proximate pairs (or other combinations) of pixels vary in predefined image quality by a threshold amount. Other edge detection techniques may be used on the result of the compared images.

In one embodiment, the light sources 28a, b are strobbed at a predefined frequency relative to the frame rate of the camera 26 (video). For example, if a camera has a raw frame rate of 60 Hz and two light sources were used then the strobe frequency would be no higher than 30 Hz on each strobe light—one for alternate frames. The rate at which the edge needs to be examined depends on the speed of the vehicle, the linearity/dynamics of the edge being tracked, the dwell of the strobe, the ability of the vehicle to coast between edge observations, and other factors. In another embodiment, the light sources 28a, b are continuously illuminated or can be alternated with various other illumination schemes (such as strobbing), thereby allowing the processor 24 to analyze various illumination schemes upon a desired surface.

FIG. 3 illustrates a surface 50 that includes a narrow channel 52 that is desired to be detected by the system 20. In order to provide better illumination enhancement, the second light source 28b has a line-of-sight with an angular difference from the line-of-sight of the camera 26 that is less than 30°. The actual angle depends on the depth and width of the slot. It may be in the same plane as the camera 26 or greater than 30°. The angles of the light sources 28a, b relative to the camera 26 and the surface 50 are set in order to produce the best illumination results for increasing edge detection by the processor 24. Also, 3 or more lights (a third light source 28c) may be needed to track the slot for left and right deviations depending on its depth/width ratio.

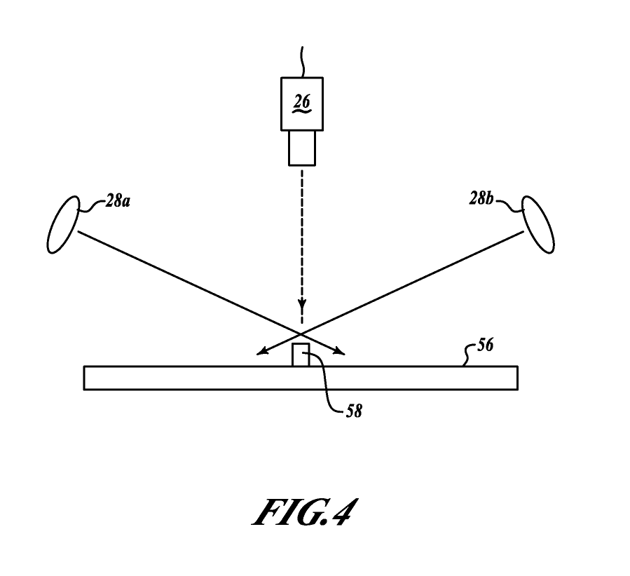

FIG. 4 illustrates another application of the system 20 for use in determining a raised edge 58 on a surface 56. Similar to the process described in FIGS. 3A, B, the light sources 28a, b are alternately illuminated thereby allowing the camera 26 to capture various images with differently angled light sources in order to analyze, compare and determine if an edge (in this case raised edge) exists.

In one embodiment of the invention, the light source 28 can be any of a number of visible illumination sources, such as fluorescent light, an incandescent light or xenon light.

The light source 28 may also produce a non-visible illumination, such as light-emitting diodes (LEDs) for producing infrared light or laser diodes for producing a laser light beam. If a laser light source is used, then mechanisms may be included for scanning the laser beam in a desired pattern along a targeted surface.

In other embodiments, more than two light sources may be used at a variety of other angles relative to the camera 26. Also, in a low-light environment a single light source might be capable of producing an adequate shadow for allowing the processor 24 to detect an edge. Any combination of illumination sources may be used. Also, the illumination source may be restricted to a certain frequency range, such as when illumination in a specific color is desired.

In one embodiment, the vehicle 18 (FIG. 1) may be any of a variety of vehicles that would benefit from having improved edge detection capabilities, for example an automated lawn mower. The edge detection capabilities discussed above could be combined with other navigation systems, such as GPS, to provide a more comprehensive autonavigation system.

If the form of the edge is fixed and known, steps up like a curb on the passenger side of a car, or steps down like the uncut-to-cut edge of turf, then the placement of the light sources and the location of the edge relative to the shadow pattern is also fixed. If the form of the edge is not fixed, the system combines some of the lighting patterns and techniques shown in the figures above to allow the system to deduce the form of the edge based on the contrast patterns produced when it is illuminated from different angles.

If the ambient light is low or the frequency of the supplemental light can be filtered from the ambient light, processing the attained images to determine the edge is much more effective since the contrast between the shadow and illuminated surfaces will be greater.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for performing edge detection on a surface, the system comprising:
a camera having a line of sight approximately perpendicular to a plane associated with the surface;
one or more illumination sources having a line of sight that is less than perpendicular to the plane by a predefined threshold amount; and
a processor in signal communication with the camera comprising:
a first component configured to receive images generated by the camera; and
a second component configured to analyze the received images and determine an edge located within one or more of the analyzed images based on the analysis.

2. The system of claim 1, wherein the one or more illumination sources includes at least one light sources located on opposite sides of the camera.

3. The system of claim 2, wherein the at least one light sources are strobed relative to a frame rate of the camera and a predefined image capturing protocol.

4. The system of claim 3, the first component is configured to separate the received images from the camera into one or more first images that are illuminated by a first one of the light sources and one or more second images that are illuminated by a second one of the light sources,
wherein the second component compares one of the one or more first images to one of the one or more second images.

5. The system of claim 4, wherein the second component compares the luminance of pixels in one of the one or more first images to one of the one or more second images, wherein the pixels in the first and second images are associated with approximately the same location on the surface.

6. The system of claim 1, wherein the light source is at least one of a fluorescent light, an incandescent light or a xenon light.

7. The system of claim 1, wherein the light source is an infrared light-emitting diode.

8. The system of claim 7, wherein the infrared light-emitting diode includes a laser diode.

9. A method for performing edge detection on a surface, the method comprising:
capturing a plurality of images using a camera having a line of sight approximately perpendicular to a plane associated with the surface;
illuminating the surface along at least one line of sight that is less than perpendicular to the plane by a predefined threshold amount; and
analyzing at least two of the captured images, wherein at least one of the at least two images is illuminated; and
determining an edge located within one or more of the analyzed images based on the comparison.

10. The method of claim 9, wherein illuminating includes illuminating the surface from light sources located on opposite sides of the camera.

11. The method of claim 10, wherein illuminating includes strobing light onto the surface relative to a frame rate of the camera and a predefined image processing protocol.

12. The method of claim 11, further comprising separating the captured images into one or more first images that are illuminated by a first light source and one or more second images that are illuminated by a second light source,
wherein analyzing compares one of the one or more first images to one of the one or more second images.

13. The method of claim 12, wherein comparing compares the luminance of pixels in one of the one or more first images to one of the one or more second images, wherein the pixels in the first and second images are associated with approximately the same location on the surface.
